(19) United States
(12) Patent Application Publication
(10) Pub. No.: US 2026/0102846 A1
(43) Pub. Date: Apr. 16, 2026

(54) LASER CUTTING SYSTEM USING A FOCUSING LENS WITH A SHORTER FOCAL LENGTH

(71) Applicant: II-VI Delaware, Inc., Wilmington, DE (US)

(72) Inventor: Danny CHAN, Berlin (DE)

(21) Appl. No.: 18/914,773

(22) Filed: Oct. 14, 2024

(51) Int. Cl. B23K 26/06; B23K 26/38

(52) U.S. Cl. CPC B23K 26/0648; B23K 26/38

(57) ABSTRACT

Laser processes use a laser beam to perform cutting, brazing, welding, or, other operations on different materials, the laser being positioned using elements of the system, such as discrete adjustment of positioning elements or dynamic movement of the laser head. For systems using high-energy lasers, the elements therein—including those which facilitate movement—may suffer from thermal difficulties. Disclosed herein is an optical head for use in a high-powered laser cutting system. In disclosed systems, the optical head includes a focusing lens having a shorter focal length than the desired working distance of the system. Further disclosed are systems which use this optical head, allowing for the desired positioning of the focus as well as magnification of the system's image. Use of the disclosed laser head within a high-powered laser system may allow for reduced thermal load on sensitive components and contamination.

### BACKGROUND

Unless otherwise indicated herein, the materials described herein are not prior art to the claims in the present application and are not admitted to be prior art by inclusion in this section.

Laser processes use a laser beam to perform cutting, brazing, welding, or other operations on different materials. High powered laser cutting heads may also cut through metals. The laser process may be controlled through the movement of a laser head to direct the laser. The laser head may be moved across a workpiece via gantries or other automated axis control arms.

The laser head may also be used to focus the laser light and introduce a process gas to assist in the laser or material process, for example to create a neutral environment and/or clear molten material or other debris from the laser process. The laser head may include one or more focusing optics as well as internal adjustments to adjust the position of the laser beam within the laser head.

### BRIEF SUMMARY

This summary is provided to introduce a selection of concepts in a simplified form that are further described below in the detailed description. This summary is not intended to identify key features or essential characteristics of the claimed subject matter, nor is it intended to be used as an aid in determining the scope of the claimed subject matter.

Disclosed herein are laser cutting systems. In one aspect of the disclosure, the laser cutting systems includes an optical head, the optical head including a housing, an optical input adapted to receive a light source, a preceding optic optically coupled to the optical input, moveably connected to the housing, and configured to produce an intermediate optical beam from the light source, a focusing optic configured to focus the intermediate optical beam into a focus, the focusing optic having a focal length and a working distance, the working distance being the distance from the focusing lens to the focal point, where the focal length of the focusing optic is less, or substantially less, than the working distance.

The disclosed laser cutting systems may further include an optical head having a focusing optic, where the focal length of the focusing optic is about 40% to about 80% of the working distance. In another aspect, the optical head may also include a workpiece placed at or overlapping with the working distance. In yet another aspect, the optical head may include an intermediate optical beam which is divergent.

The disclosed laser cutting systems may further include an optical head, where the optical head includes a preceding optic, where the preceding optic is moveably connected to the housing via one or more actuators. In another aspect, disclosed actuators may include at least one of a linear motor, a stepper motor, a spindle motor, and/or a voice coil motors. In yet another aspect, disclosed actuators may include bearings, and the one or more actuators and/or bearings may thermally isolate the preceding optics from the housing.

The disclosed laser cutting systems may further include an optical head having a focusing optic which can be used at finite conjugates. In another aspect, an optical head includes one more mechanical stops between a preceding optic and a focusing optic, the one or more mechanical stops including an aperture therewithin optically aligned with the intermediate optical beam. In another aspect, the focusing optic is adjustably connected to the housing to allow for mechanical adjustments.

The disclosed laser cutting systems may further include an optical head having a light source. In another aspect, the light source of the optical head may be a laser. In another aspect, the light source may have an optical power output of greater than about 8 kilowatts (kW). In yet another aspect, the light source of the optical head may optically couple to the optical input via a fiber optic cable.

Additionally disclosed herein are laser cutting systems, where the laser cutting systems include a workpiece, a laser source, and the preceding optical head. In another aspect, the system may be configured such that at least one of the laser source, the optical input, and the preceding optics emits divergent light incident onto the focusing lens. In another aspect, the system may also separate the focusing optics and the workpiece via a protection window therebetween. In another aspect, the system may use a focusing lens where the focal length is from about 40% to about 80% of the working distance. In another aspect, elements of the optical head of the system may be positioned to achieve a desired magnification or a desired working distance. In yet another aspect, the focal lens used by the system may have an adjustment translation ratio (“M”) greater than one, this factor being defined as M=WD/FL, where “WD”is the desired working distance and “FL”the focal length of the focusing lens.

The adjustment translation ratio is a proportionality factor that describes how much the focus point moves laterally when the focusing lens is moved laterally. In a standard system with a collimated input beam to the focusing lens, the focus point moves exactly as much as the focusing lens if it is moved.

Other technical features may be readily apparent to one skilled in the art from the following figures, descriptions, and claims.

### BRIEF DESCRIPTION OF THE SEVERAL VIEWS OF THE DRAWINGS

FIG. 1 shows a schematic view of a laser cutting system according to the present disclosure.

FIG. 2 shows a schematic view of a laser cutting system in accordance with the disclosure.

FIG. 3 shows a schematic view of portions of a laser head in accordance with the disclosure.

FIG. 4 shows a schematic view of a portion of a laser head in accordance with the disclosure.

FIG. 5 shows a schematic view of a portion of a laser head in accordance with the disclosure.

FIG. 6 shows a schematic view of a laser cutting system in accordance with the disclosure.

### DETAILED DESCRIPTION

It is to be understood that the figures and descriptions of the present invention may have been simplified to illustrate elements that are relevant for a clear understanding of the present embodiments, while eliminating, for purposes of clarity, other elements found in a laser cutting system, optical head, or related systems. Those of ordinary skill in the art will recognize, upon reading this disclosure, that other elements may be desirable and/or required in order to implement the present embodiments. However, because such elements would be understood from reading this disclosure, and because they are not required to facilitate a better understanding of the present embodiments, a discussion of such elements is not provided herein. It is also to be understood that the drawings included herewith only provide diagrammatic representations of the presently preferred structures of the present invention and that structures falling within the scope of the present embodiments may include structures different than those shown in the drawings. Reference will now be made to the drawings wherein like structures are provided with like reference designations.

Traditionally, while thinner materials, or materials that readily absorb laser light, can be cut with relatively lower powered lasers, relatively high powered systems are more advantageous for cutting thicker materials and those materials that do not easily absorb laser light, for example metal. It can also be advantageous to have precise control of the location and shape of the how the laser exits the laser head. Such control can enable an optical beam to exit the laser head inline with the process gas and with the desired focus and position for a particular workpiece and processing conditions. The alignment and control of a laser may include one or more optics, mounts, and adjusters within the laser head. Further, the inside of the laser head may be sealed from the outside to protect its internals from dust, material off-gassing, soot, and other contaminants.

High powered systems necessarily increase the amount of energy and thermal load within the laser head, for example due to reflections, absorption, misalignment, and/or other absorptive or reflective losses. Such additional thermal energy may cause damage to the laser head and internal components. While the outside of a sealed laser head may be cooled using heat exchangers and heat sinks, internal components, particularly those adjustably mounted within and to the laser head housing are more at risk because their respective mounts may thermally isolate the internal components from the housing, i.e., they are not in ready thermal contact with the cooled laser head housing.

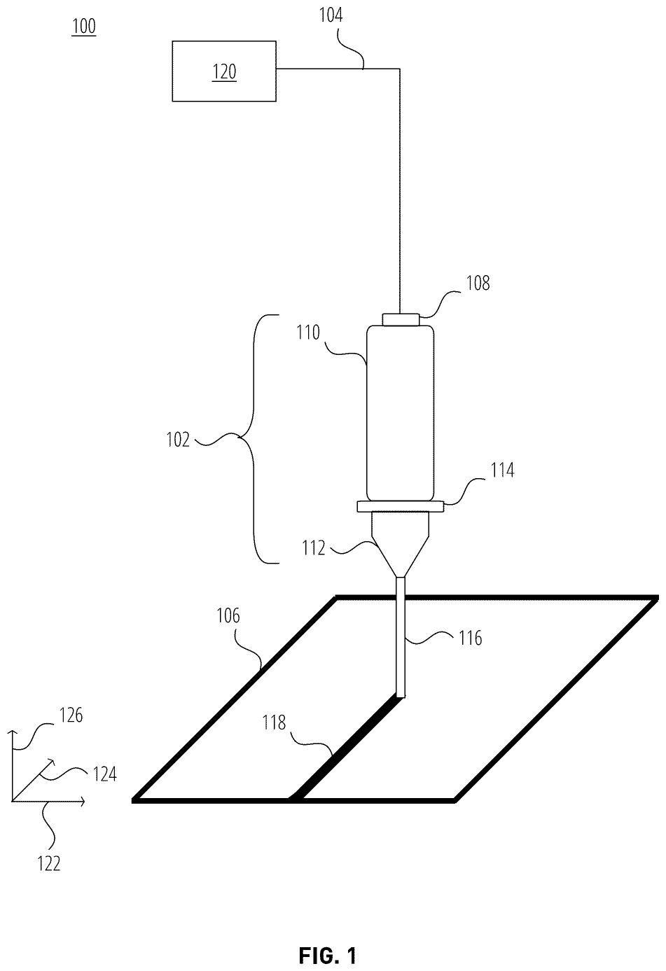

FIG. 1 illustrates a schematic view of a laser cutting system 100 according to the present disclosure. In this perspective, the top surface of the workpiece 106 is in the plane of the x-axis 122 and y-axis 124, and the direction of the focused optical beam 116 is aligned with the z-axis 126 and shown as normal to the surface of the workpiece 106 and the x-axis 122 and y-axis 124. Although the focused optical beam need not be aligned with the z-axis 126 (and normal to the workpiece 106), the remainder of the disclosure will be described accordingly for clarity.

The laser cutting system 100 is used to direct a focused optical beam 116 onto a workpiece 106 in order to create a cut 118 (or kerf) in the material. A source laser 120 is optically coupled to a laser head 102, which focuses the light into a focused optical beam 116 and directs it toward the workpiece 106 along with any desired process gas (not shown). The laser 120 may optionally be physically separated from the laser head 102 and optically coupled to the laser head 102 through a waveguide, e.g., one or more optical fibers 104 input through one or more optical inputs, shown schematically as connector 108, which optically conducts the laser 120 energy into the laser head 102. The laser head 102 may include a housing 110 that holds one or more internal optics.

The housing may be hermetically sealed against dust and gas intrusion. To further protect the internal optics inside the housing 110, the laser head 102 may optionally include a protective window 114 between the inside of the housing 110 and workpiece 106 (i.e., optically “downstream”) separating the inside of the housing 110 from the outside. This protective window 114 is effectively transparent to the focused optical beam 116.

The laser head 102 may include a nozzle 112 further optically downstream from the protective window 114. The nozzle 112 directs the process gas toward the workpiece 106 and also allows the focused optical beam 116 to pass therethrough, for example, though a hole at its tip. The nozzle 112 may also include sensing components for monitoring a standoff or gap of the nozzle 112 from a workpiece 106.

In general, the laser cutting system 100 can be used with a gantry assembly, a robotic arm, or other apparatus, at various angles and orientations, via a control system, such that the focused optical beam 116 from the laser head 102 can be moved relative to a workpiece 106, and monitored using various position and feedback sensors.

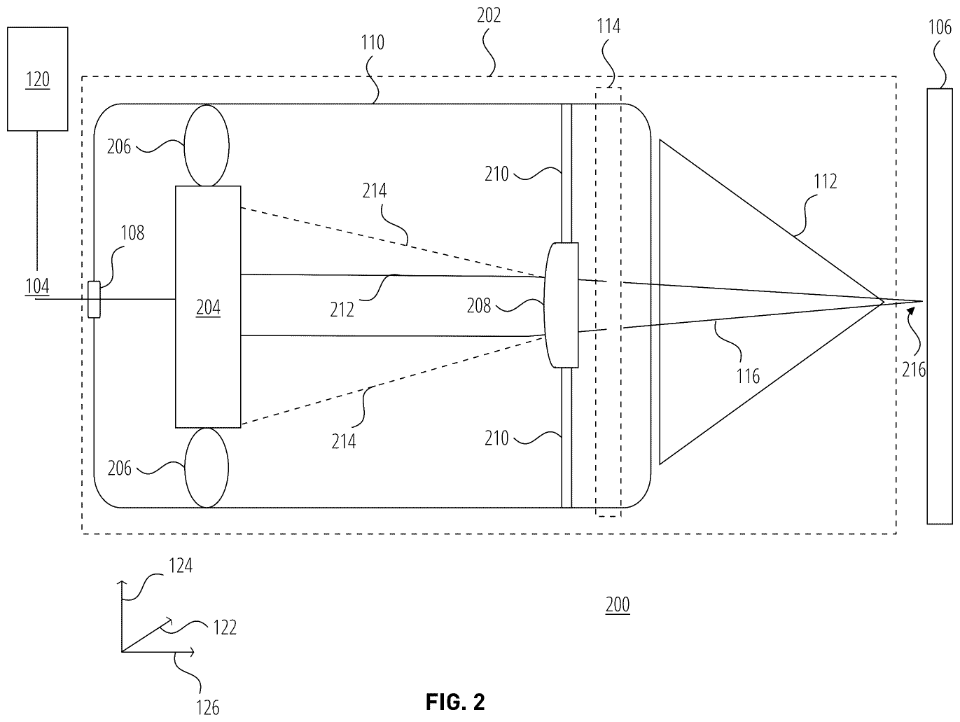

FIG. 2 is a laser cutting system 200 (similar to laser cutting system 100 of FIG. 1) showing a portion of the interior components of the laser head 202 (similar to laser head 102 of FIG. 1). The laser head 202 is shown including a housing 110 and a nozzle 112 emitting a focused optical beam 116.

Similar to the laser cutting system 100, laser cutting system 200 includes a source laser 120 coupled to a housing 110 through an optical fiber 104 and connector 108. Within the housing 110, the source light of the laser 120 is optically coupled from the optical fiber 104, to one or more preceding optics 204. The preceding optics 204 are configured and arranged to provide an intermediate optical beam 212 that provides optical coupling at an appropriate optical field to one or more focusing optics 208. The preceding optics 204 may be, for example, one or more monolithic lenses, mirrors, or beam shaping elements either individually or together as an optical/lens group grouped/connected optically and/or physically fixed relative to each other. If a lens group, the preceding optics 204 may include one or more fixed elements and/or one or more moveable elements, which may be translated and/or tilted. In one example, preceding optics 204 may include a collimation lens group with a fixed positive focal length. These preceding optics 204 may be movable along the optical axis. More complex embodiments of the preceding optics 204 may have multiple movable parts, for example: a set of one or more lens groups, which may be moved along the optical axis and move the focus 216 along the z-axis 126; a beam steering system, which may consist of one or more moveable mirrors, which moves the focus 216 along the xy-plane 122, 124; a beam shaping system that changes the shape of the focus 216 (i.e., creating a “ring mode” of the focus 216). As shown in the example of FIG. 2, the intermediate optical beam 212 is collimated, which may be desired to provide modularity with other optical components, i.e., to readily include other optical components, for example beam bending, process monitoring, etc.

The focusing optic 208 optically focuses the intermediate optical beam 212 into the focused optical beam 116 directed toward the workpiece. While shown as a single optic, the focusing optic 208 may include one or more separate or combined optics. The focused optical beam 116 has a focus 216 that is shown schematically as being proximate to the workpiece 106. However it should be understood that, based on the desired processing characteristics, the actual focus 216 may be positioned above, within, or below the workpiece (along the z-axis 126) and the location of focus 216 is merely shown for illustration purposes. Further the focus 216 may not be an actual focus “point” but may instead be the region of the focused optical beam 116 at its smallest diameter when viewed as a cross section across the direction of travel of the beam, for example along the z-axis 126.

The focusing optic 208 may include a lens mount (not shown) for retaining the focusing optic 208. The focusing optic 208 may be adjustably mounted to the housing 110 via one or more mechanical adjustments 210, which may be, for example a one or two dimensional lateral translation mechanism, which may be adapted to translate the focusing optic 208 vertical to the optical axis, for example with respect to the z-axis 126. The mechanical adjustments 210 may provide the ability to adjust the focusing optic 208 in one or more axis (e.g., 122, 124, 126) to optically align the focusing optic 208. The laser head 202 may optionally include a protective window 114 and a nozzle 112, as previously discussed. Additional windows, not shown, may be used to create additional similar barriers for contaminants. Such windows, for example, protective window 114, may be placed in a removeable drawer (not shown) to provide for exchanging or cleaning the protective window 114. The drawer may further include one or more seals to prevent dirt and other contaminants from entering the housing 110 and contaminating the internal optics. However, the seal may reduce thermal conductivity of the window to the housing 110. As a result, with additional thermal energy in the housing 110, at elevated temperatures, the drawer and seals may more easily overheat, causing the seal(s) to outgas, which may contaminate the preceding optics 204 and/or focusing optic 208. Although not shown for clarity, in addition to the focusing optic 208, additional beam shaping elements may also be included within the housing 110.

The preceding optics 204 may be adjusted via a set of actuators 206, which may be mechanical, electrical, or electro-mechanical, and are configured to couple the preceding optics 204 (including any association lens mounts (not shown)) to the housing 110. The actuators 206 may be, for example, linear motors, stepper motors, spindle motors, voice coil motors. The actuators 206 function to mechanically mount the preceding optics 204 to the housing 110 (optionally through one or more lens mounts) and to provide for positional modifications of the preceding optics 204 relative to the housing 110. The actuators 206 may include bearings to provide for smooth operation. Such actuator movement can be during setup/installation and fixed during processing (e.g., laser cutting) or the movement can be dynamic and changed during processing, for example, to impart small variations in the position of the focus 216 relative to any other movements of the laser head 202. Movement of the preceding optics 204 (e.g., with the actuators 206) may move the focus 216, or otherwise adjust the position of the preceding optics 204 in the x-axis 122, the y-axis 124, and/or the z-axis 126. Additionally, the one or more actuators 206 can impart positional modifications in one or more axes such that the shape of the beam is changed. These positional modifications may occur continuously during operation. If the actuators 206 are electromechanical, the actuators 206 provide the added advantage of being able to impart positional modifications to the preceding optics 204 via electrical signals from a laser system controller while minimizing contamination intrusion into the laser head 202. While the actuators 206 provide the advantages of positionally adjusting the preceding optics 204, they also increase the thermal isolation of the preceding optics 204 from the laser head 202, for example, due to one or more bearings within the actuators 206 that enable their functionality. This thermal isolation may present an even greater challenge for high powered laser heads, e.g., those over 8 kW. In such high-powered systems, it can be advantageous to further minimize particle generation due to friction therein to prevent such particles from interacting with the optical power. As such there may an increased use of bearings and other friction reducing systems and materials that thermally isolate internal components from the housing. Such thermal isolation may decrease the ability of the laser cutting system 200 to remove thermal load from the preceding optics 204 and/or actuator 206. The actuators 206, and/or bearings within them, may also include seals and/or grease to reduce wear, and such seals and/or grease may cause outgassing at elevated temperatures, which may lead to contamination of optics within the housing 110.

For example, as shown, a portion of the intermediate optical beam 212, upon incidence to the focusing optic 208, create back reflections 214. These back reflections 214 are, for example, due to the finite performance of anti-reflection coatings, the angle of incidence of the intermediate optical beam 212, the refractive index of the material of the focusing optic 208, and/or the focusing optic 208. The refractive index may also contribute to additional changes in the position of back reflections. These changes may be due to the reflections coming from the downstream surface of an element. Such reflections may cause an increase in thermal loads within the housing 110, for example, the back reflections 214 may cause the preceding optics 204 and or actuators 206 to increase in temperature, which may be exasperated due to their thermal isolation from the housings 110, and which can ultimately lead to damage, premature end-of-life, and/or outgassing of grease and seals.

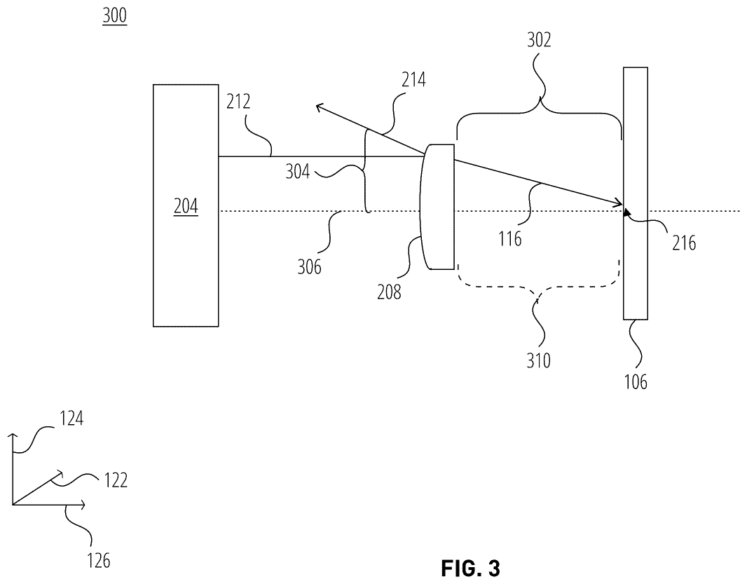

FIG. 3 shows a simplified schematic view of a portion of example laser head components, for example those of laser head 202, shown as optical system 300. For ease of illustration, half of the intermediate optical beam 212 and focused optical beam 116 are shown, the other halves are implied as being mirrored (or rotated around) across the centerline 306 of the respective beams.

As shown, back reflection 214 forms an angle of reflection 304, which is shown as the angle made by the outer extent's back reflection with the centerline 306. The focus 216, where the focused optical beam 116 coalesces, occurs at a working distance 302 from the focusing optic 208 along the z-axis 126 (which is also parallel to the centerline 306 and the optical axis of the focusing optic 208). The working distance 302 is the actual distance to the focus 216 from the last surface of the focusing optic 208, the last surface being the surface of the optical element closest to the workpiece 216 or output of the laser head 202 along the centerline 306.

The working distance 302 can be modified by the internal setup of the focusing lens and/or the existence of protection windows or other components, while the focal length 310 of the focusing optic 208 (or any lens) is a fixed characteristic of a particular focusing optic 208 and is a measure of how strongly the focusing optic 208 converges (or diverges light). For purposes of this disclosure, the working distance and focal length do not take into account any interceding windows, but are the optical equivalents in air. As would be understood by a person of ordinary skill in the art based on the disclosure, such distances may be adjusted accordingly based on such interceding windows. For example, where each plane parallel protection window (i.e., an interceding window) contributes only a thickness of t/n, where “t” is the thickness of the window along the optical axis of the lens and “n” is the refractive index of that window at the design wavelength of the system. For example, if the physical distance from lens to focus point is 151.575 mm, and there is one interceding window with a thickness of 5 mm having a refractive index of 1.4995, the optically relevant working distance is 151.575−5+5/1.4995=149.9 mm. As shown, with the example collimated intermediate optical beam 212, the focal length 310 of the focusing optic 208 is equivalent to the working distance 302.

It should also be understood, based on this disclosure, that the focal length of a lens (for example, a single monolithic focus lens) is typically measured from the second principal plane associated with the output of the lens, the virtual plane determined by the lens used and the wavelength to be considered. This virtual plane would typically be within the physical boundaries of the lens. For a planoconvex lens, the second principal plane may be a distance away from the second physical lens surface, the distance being a fraction of the center thickness. For example, for planoconvex lens, with the plano side oriented towards the focus, the second principal plane is located inside the lens at ⅓ of the lens center thickness from the second surface.

As such, even if the optical distances of the focal length (FL) and working distance (WD) are the same, the focal length's physical distance may be slightly larger due to the offset of the principal plane into the lens. However, because such offset distance in typical laser high powered laser systems is relatively small, e.g., on the order of several millimeters, i.e., about 10 mm or less, for purposes of this disclosure that distance will not be accounted for in further discussion, noting that both the focal length and working distance are depicted as being from the second (exit) surface of the focusing optic 208.

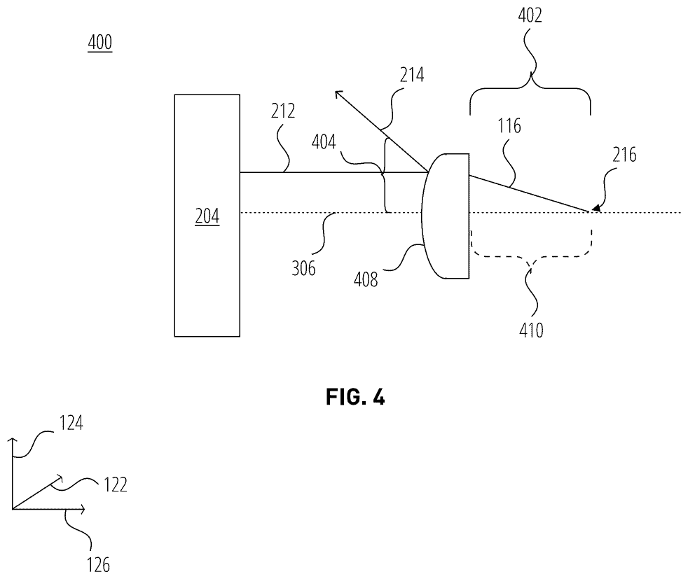

FIG. 4 shows a simplified schematic view of a portion of example laser head components, for example those of laser head 202, shown as optical system 400. Optical system 400 is the same as optical system 300, except that focusing optic 408 of optical system 400 has a focal length 410 that is shorter than focal length 310 (FIG. 3), causing the focused optical beam 116 to focus at a working distance 402 that is shorter than the working distance 302 (FIG. 3). As shown, with the example collimated intermediate optical beam 212, the focal length 410 of the focusing optics 408 is equivalent to the working distance 402.

The decrease in focal length 410 of the focusing optic 408 may be caused in part by an increase in the curvature of the face of the focusing optic 408 onto which the intermediate optical beam 212 is incident. The differing shape of focusing optic 408 also causes the back reflection 214 to have an angle of reflection 404 greater than angle of reflection 304 (FIG. 3), which may result in the beam being spread over a larger angular space, resulting in a comparatively smaller power density, and thereby less thermal energy incident on to temperature sensitive components, e.g., preceding optics 204 and/or actuator 206 (FIG. 2). In one example, the angle of reflection 404 is adjusted in response to the positioning desired to prevent optical contamination due to splatter and fumes. This positioning may be defined by the desired magnification of the total system or the desired working distance.

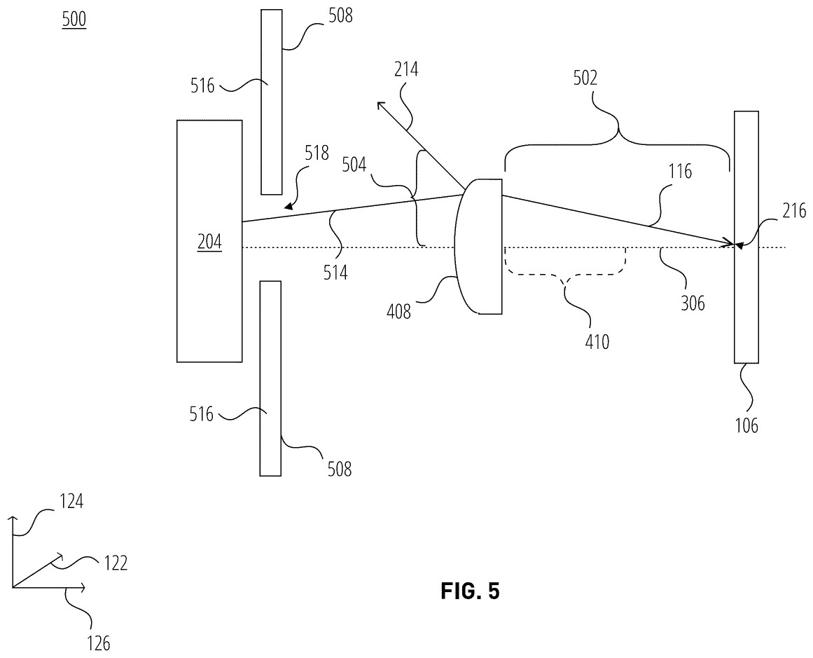

FIG. 5 shows a simplified schematic view of example laser head components, for example those of laser head 202, shown as optical system 500. Optical system 500 is the same as optical system 400, including the same focusing optic 408 having a relatively decreased focal length 410 (compared to focal length 310 in FIG. 3). However, in optical system 500, the intermediate optical beam 514 (with only half of the beam shown for clarity) is divergent from the centerline 306, i.e., the intermediate optical beam 514 is divergent from the preceding optics 204.

Based on the divergent intermediate optical beam 514, and the configuration of the focusing optic 408, the working distance 502 of optical system 500 is greater than the focal length 410 of the focusing optic 408 of FIG. 4. Further, the back reflection 214 has an angle of reflection 504 greater than angle of reflection 304 (FIG. 3) and the angle of reflection 404 (FIG. 4), which may result further in comparatively less light, and thereby less thermal energy incident onto preceding optics 204 and/or actuator 206 (FIG. 2). In one example configuration, the focal length 410 may be less than about 80% the working distance 502, or from about 40% to about 80% the working distance 502.

The preceding optics 204 are configured to generate a divergent intermediate optical beam 514, meaning the cross-sectional area of the intermediate optical beam 514 increases progressing in the beam's direction of travel (i.e., downstream). The preceding optics 204 may include an element with the appropriate position relative to the fiber tip, having been adjusted to generate divergent light. This adjustment may be accomplished for one or more positive or negative lenses individually or within a lens group. In addition, the divergent intermediate optical beam 514 may be generated, alternatively or in addition to the preceding optics 204, through other components. For example, adjusting the laser system used to create the source light. Additional embodiments may include both adjusting the laser system generating the source light and adjusting the preceding optics in tandem.

As an additional optional or alternative feature, optical system 500 (and/or optical system 400) may further include one or more mechanical stops 508 between the preceding optics 204 and the focusing optic 408. The mechanical stop 508 may include an aperture 518, or otherwise transparent region, to allow the intermediate optical beam 514 to pass therethrough. Mechanical stop 508 may further include an opaque region 516 that is opaque or partially opaque to the back reflection 214 and configured to be positioned between the back reflections 214 and the actuators 206 and/or preceding optics 204. The one or more opaque regions 516 may include multiple regions, or alternatively it may include a single connected region annularly surrounding the aperture 518. The mechanical stop 508 may be positioned such that the back reflections 214 from the focusing optic 408 are directed to be incident to the opaque regions 516 of the mechanical stop 508 rather than the preceding elements such as the preceding optics 204, or alternatively such that at least a portion of the back reflections 214 are incident thereto. The mechanical stops 508 may be mechanically connected to the housing 110 (not shown) to provide positioning support and thermal transfer from the mechanical aperture to the housing 110 (not shown).

The optical system 500 has an added advantage in that the relative movement of either the preceding optics 204 and the focusing optic 408 in any of axes 122, 124, and/or 126, i.e., movement of the preceding optics 204 and/or the focusing optic 408 results in a magnified corresponding movement of the focus 216. For example, depending on the arrangement the particular laser cutting system 100, the focused optical beam 116 may need to be repositioned to be coaxial with the end of nozzle 112 (FIG. 1), in which the focusing optic 408 may be adjusted in one or more axes 122, 124, and/or 126 by a distance “d” in a first direction and, because the working distance 502 is greater than the focal length 410, the resulting movement of the focus 216 in that direction will be greater than “d” by a magnification adjustment translation ratio “M”. That is, it has an adjustment translation ratio greater than one. As noted above, the adjustment translation ratio is a proportionality factor that describes how much the focus point moves laterally when the focusing lens is moved laterally. In a system having a collimated input beam to the focusing lens with M=1, if the focusing lens is moved a distance, then the focus point moves exactly as much as the focusing lens.

In one example configuration, the adjustment translation ratio (M) may be from about 1.2 to about 2.5, analogous to the focal length being from about 40% to about 80% the working distance. Given the working distance (WD) and the focal length (FL), this adjustment translation ratio follows M=WD/FL. In one example having a working distance of 150 units, and a focal length of 50 units, the adjustment translation ratio factor is M=150/50=3. Further, such an adjustment translation ratio is greater than that of the comparative system above, wherein the adjustment translation ration is equal to 1 and in which the focal length and working distance are equal. For example, in the system having a lens wherein M=1, a movement of the focusing lens by a distance t moves the spot relative to the nozzle by the same amount. However, in the system having a lens wherein M=3, because of this magnification, the focusing optic 408 may be designed with a smaller lens diameter to obtain the same design movement capabilities (which can be simpler to manufacture and/or require less lens material) and can also decrease the internal space requirements of the housing 110. Additionally, less design movement of the preceding optics 204 is required to impart the same amount of movement of the focus 216.

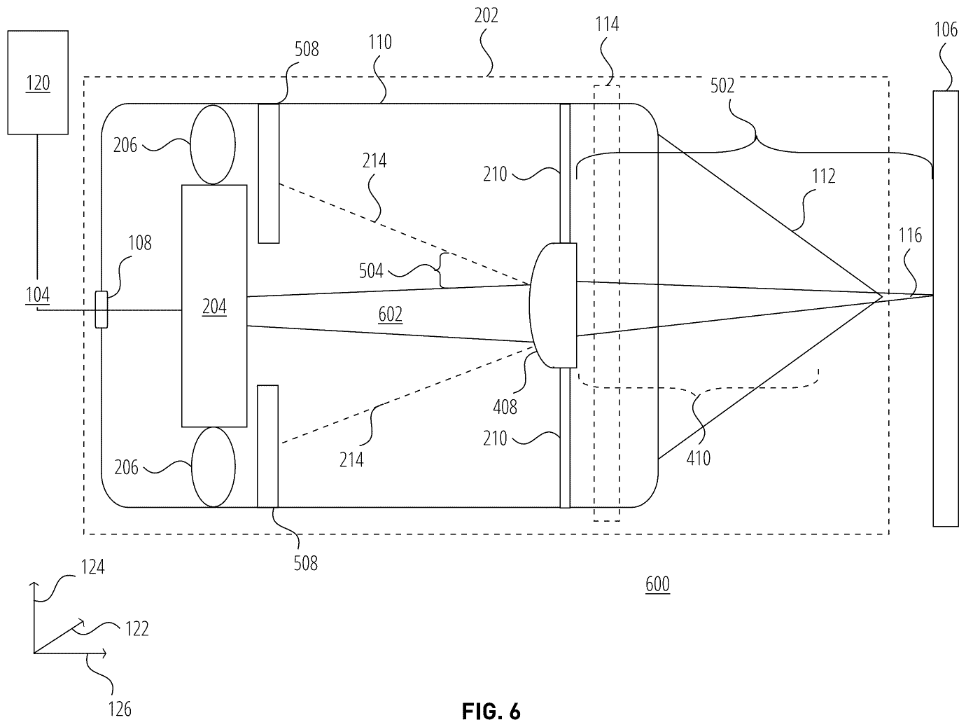

FIG. 6 is a laser cutting system 600 showing the interior components of the laser head 202, including a housing 110 and a nozzle 112. Laser cutting system 600 is similar to laser cutting system 200, except using the optical system 500 (described with respect to FIG. 5).

Laser cutting system 600 includes the source laser 120 coupled to the housing 110. Within the housing 110, the source light of the laser 120 is directed from the optical fiber 104, through one or more optional connectors 108, to one or more preceding optics 204 that is adjustably mounted to the housing 110 through one or more actuators 206. The preceding optics 204, which are optically coupled with the laser 120 via optical fiber 104 emit an intermediate optical beam 602 that is divergent. The intermediate optical beam 602 is incident onto one or more focusing optics 408 having a focal length 410. Focusing optic 408 then emits focused optical beam 116, which is directed through the nozzle to be emitted by the system toward a workpiece 106. Additionally, the focusing optic 408 may be similarly separated from the nozzle 112 via a protective window 114, which may be transparent.

The focusing optic 408 may be similarly held into place via an adjustment mechanism, such as the mechanical adjustment 210. The resulting focused optical beam 116 results in a working distance 502 that is greater than the focal length 410.

As discussed previously, generated back reflections 214 may have an increased angle of reflection 504 and may result in less light incident onto preceding optics 204 and/or actuators 206. Further, an optional mechanical aperture 508 is shown which may additionally absorb or block back reflections 214. As disclosed, such back reflections 214 may cause thermal difficulties within the housing 110 system, particularly in high-energy applications.

The system depicted in this laser cutting system 600—as well as other embodiments using a combination of similar, previously described features—may result in certain unique benefits due to the presence of these unique features over prior laser cutting systems and laser heads. Examples of these benefits may include: reducing the back reflection to the fiber connector itself; larger safety margins when cutting with the system; being able to use a streamlined, less bulky, laser head; simpler manufacturing; higher process stability; and avoiding the use of complex cooling mechanisms.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more. ” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,”the term “includes”should be interpreted as “includes but is not limited to,”etc.). Furthermore, in those instances where a convention analogous to “at least one of A, B, and C, etc. ” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

The described embodiments are therefore to be considered in all respects only as illustrative and not restrictive. All changes which come within the meaning and range of equivalency of the claims are to be embraced within their scope

In exchange for disclosing the inventive concepts contained herein, the Applicants desire all patent rights afforded by the appended claims. The scope of the invention is indicated by the appended claims rather than by the foregoing description. Therefore, it is intended that the appended claims include all modifications and alterations to the full extent that they come within the scope of the following claims or the equivalents thereof.

What is claimed is:

1. An optical head, comprising
a housing;
an optical input adapted to receive a light source;
a preceding optic optically coupled to the optical input and moveably connected to the housing and configured to produce an intermediate optical beam from the light source;
a focusing optic configured to focus the intermediate optical beam into a focus, the focusing optic having a focal length;
a working distance, the working distance being the distance from the focusing lens to the focus;
wherein the focal length of the focusing optic is less than the working distance.

2. The optical head of claim 1, where the focal length is about 40% to about 80% of the working distance.

3. The optical head of claim 1, wherein the preceding optic is moveably connected to the housing via one or more actuators.

4. The optical head of claim 3, wherein the one or more actuators thermally isolate the preceding optics from the housing.

5. The optical head of claim 3, wherein the one or more actuators include at least one of a linear motor, a stepper motor, a spindle motor, and/or a voice coil motor.

6. The optical head of claim 1, further comprising the light source.

7. The optical head of claim 1, further comprising a workpiece at the working distance.

8. The optical head of claim 1, wherein the intermediate optical beam is divergent.

9. The optical head of claim 1, wherein the focusing optic can be used at finite conjugates.

10. The optical head of claim 1, further comprising one or more mechanical stops between the preceding optic and the focusing optic, the one or more mechanical stops including an aperture therewithin optically aligned with the intermediate optical beam.

11. The optical head of claim 1, further comprising mechanical adjustments which adjustably connect the focusing optic to the housing.

12. The optical head of claim 1, wherein the light source is a laser.

13. The optical head of claim 1, wherein the light source is greater than 8 kilowatts.

14. The optical head of claim 1, wherein the light source optically couples to the optical input via a fiber optic cable.

15. A laser cutting system, the system comprising
a workpiece;
a laser source; and
the optical head of claim 1.

16. The system of claim 15, wherein at least one of the laser source, the optical input, and the preceding optics are configured as to emit divergent light.

17. The system of claim 15, wherein the focusing optics and the workpiece are separated by a protection window therebetween.

18. The system of claim 15, wherein the focal length of the focusing lens is from about 40% to about 80% of the working distance.

19. The system of claim 15, wherein the adjustment translation ratio (“M”) of the focal lens used by the system is an adjustment translation ratio greater than one, where the adjustment translation ratio is equal to the working distance (“WD”) divided by the focal length (“FL”) of the focusing lens in the system (i.e. M=WD/FL ).

20. The system of claim 19, wherein the adjustment translation ratio is about 1.2 to about 2.5.
